(19) United States
(12) Patent Application Publication
(10) Pub. No.: US 2005/0137972 A1
(43) Pub. Date: Jun. 23, 2005

(54) Methods and systems for the processing of credit payment data

(76) Inventor: Bruce E. Krumlauf, Centennial, CO (US)

Correspondence Address: John S. Beulick;Armstrong Teasdale LLP, Suite 2600, One Metropolitan Square, St. Louis, MO, 63102, US

(21) Appl. No.: 10/739,846

(22) Filed: Dec. 18, 2003

(51) Int. Cl. G06F 17/60

(52) U.S. Cl. 705/40; 705/42

(57) ABSTRACT

A method for processing child support credit payment instructions is described. The method includes receiving payment instructions from one or more employers on behalf of one or more employees, formatting the payment instructions into a data format specified by banks of the employers, and forwarding the data formatted payment instructions to the banks of the employers. In a specific implementation, the employer is witholding payments from the wages of an employee.

### BACKGROUND OF THE INVENTION

This invention relates generally to processing of credit payments, and more specifically, to methods and systems for the processing of credit payment data.

An employer is sometimes requested or required to withhold certain obligations from an employee's wages and to remit finds to a government agency's designated bank. One example of such an obligation is child support payments. For child support, the amount withheld from the employee's wages by the employer is then forwarded from the employer's bank to the agency's bank and then on to the agency (e.g. a state administrative agency) for disbursement to, for example, a custodial parent.

Remitting child support payments directly from the wages of an employee places an administrative burden on an employer. In addition to administering the withholdings, the employer must also ensure that the withholdings from the employee's earnings are provided to the proper agency.

### BRIEF DESCRIPTION OF THE INVENTION

In one aspect, a method of processing child support credit payment instructions is provided. The method comprises the steps of receiving payment instructions from one or more employers on behalf of one or more employees, formatting the payment instructions into data formats specified by banks of the employers, and forwarding the data formatted payment instructions to the banks of the employers. The method may also comprise consolidating the payment instructions from multiple employers. In a specific aspect, a user interface is provided enabling employers to input and originate the payment instructions for sending to the data processor.

In another aspect, a computer system is provided that is programmed to receive payment instructions from at least one employer relating to one or more employees, convert the payment instructions into a data format specified by banks of the at least one employer, and forward the converted payment instructions to the banks of the at least one employer.

In still another aspect, a computer program is provided. The computer program comprises software modules for receiving payment instructions from at least one employer, the payments being withheld from the wages of one or more employees, converting the payment instructions into a data format specified by banks of the at least one employer, and forwarding the converted payment instructions to the banks of the at least one employer.

### BRIEF DESCRIPTION OF THE DRAWINGS

FIG. 1 is a flowchart illustrating a method for processing credit payments.

FIG. 2 is a diagram illustrating some of the participants in a credit payment flow.

FIG. 3 is table illustrating a payment related information field for child support payments.

FIG. 4 is an example CCD+ file.

FIG. 5 is an example CTX file utilizing an ASC X12 820 transaction set.

FIG. 6 is a diagram of a computer system that may be utilized for the processing of credit payments.

### DETAILED DESCRIPTION OF THE INVENTION

The systems and methods described herein are generally directed to facilitating payment instructions from diverse sources, for example, a number of different employers, into formats that are compatible with funds transfer protocols utilized by financial institutions such as banks, credit unions and like facilities. Such protocols are utilized by those financial institutions that are connected to the automated clearinghouse (ACH) network, and provide National Automated Clearing House Association (NACHA) compatible funds transfer messages. While the systems and methods described herein illustrating such funds transfers are typically described in terms of an employer remitting credit payments withheld from an employee's wages, the descriptions should not be construed to be so limiting.

Employers need to know to which bank the payments for a specific agency are to be sent and should structure the payment instructions so that they can be processed and originated by the employers bank. The payment instructions should also be structured so that they can be received and processed by the agency's bank. The payment instructions must be structured so that the receiving agency can process the payment instructions so that the payments can be made to, for example, the custodial parent.

A technical effect of the systems and methods described herein include an automatic data formatting of payment instructions received from one entity into a format requested by a second entity, the second entity debiting the first entity's account. The systems and methods for the transferring of funds are applicable to any type of payment instructions that a party forwards to a second party for processing.

In one embodiment, the payment instruction methods are embodied as a computer program embodied on a computer readable medium implemented utilizing Java® and Structured Query Language (SQL) with a client user interface front-end for administration and a web interface for standard user input and reports. (Java is a registered trademark of Sun Microsystems, Inc., Palo Alto, Calif.). In an example embodiment, the payment instruction system is web enabled and can be run from a business-entity's (i.e. employer, financial institution) intranet. In yet another embodiment, the system is fully accessed by individuals having an authorized access outside the firewall of the business-entity through the Internet. In a further example embodiment, the system is being run in a Windows® NT environment (Windows is a registered trademark of Microsoft Corporation, Redmond, Wash.). The application is flexible and can be run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

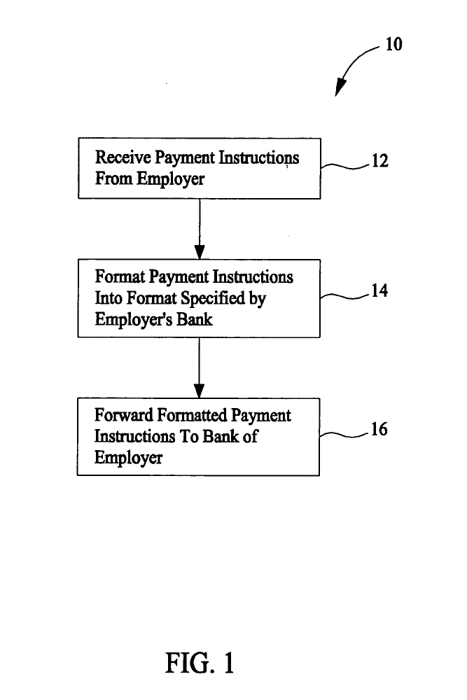

FIG. 1 is a flowchart 10 illustrating a method for processing credit payments. Referring to flowchart 10, the technical effect of a system utilizing the herein described methods is achieved when payment instructions from an employer are received 12, formatted 14 into a data format specified by a bank of the employer, and the data formatted payment instructions are forwarded 16 to the bank of the employer. In an exemplary embodiment of the described method, the credit payments processed are withheld from the wages of an employee. Examples of such withholdings include, but are not limited to, child support payments, deposits for individual income taxes, and the payment of back taxes. Specifically with respect to child support, the credit payments are at least one child support payment owed by an employer's employee to a state disbursement unit (SDU). As used herein, state disbursement unit includes any governmental or quasi-governmental entity that is responsible for collection and disbursement of child support or other payments.

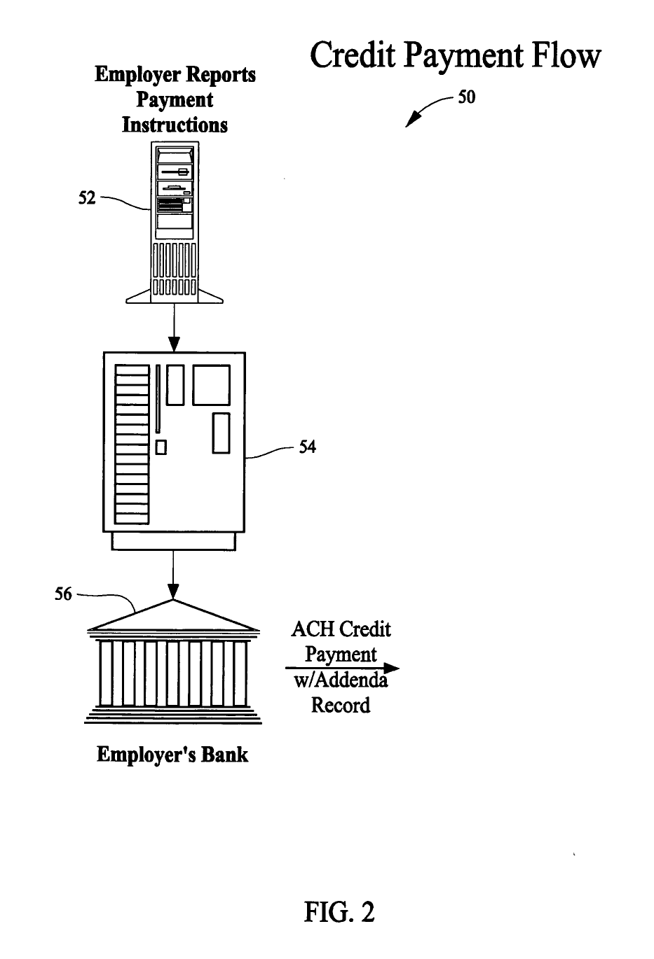

FIG. 2 is a diagram 50 illustrating participants in such a credit payment flow. Referring to FIG. 2, an employer 52 reports payment instructions to a data processor 54. In a specific embodiment, a user interface is provided which enables employers to input and originate the payment instructions for sending to data processor 54. In the embodiment, an employer user of the user interface wherein the employer is prompted to report data elements required by the receiving SDU. Further, data processor 54 validates employer reported data (e.g., the payment instructions) for compliance with requirements proliferated by individual SDUs prior to acceptance by data processor 54. Therefore, an employer receives immediate confirmation that a payment instruction substantially complies with SDU published data specifications. When the entered data does not comply with the data specifications, data processor 54 will send employer 52 one or more messages indicating that the payment instruction fails to comply with the SDU published data specifications. Alternatively, employer 52 can review and modify payment instructions prior to transmitting for processing.

Data processor 54 processes the payment instruction data provided by employer 52 into a format that is compatible with a data format utilized by a particular financial institution, for example, an employer's bank 56. In one scenario, the financial institution may make a specific request as to a data format for the payment instructions and data processor 54 processes the payment instruction data to comply with the request.

In one embodiment, data processor 54 processes the payment instruction data provided by employer 52 into a NACHA CCD+ format. In such an embodiment, remittance details for a single payment are conveyed in an 80-character Payment Related Information field of the single DED (Deduction) Addenda Record within the CCD+ instruction. CCD is a credit or debit ACH entry initiated by an organization to consolidate funds of that organization from its branches, franchises or agents, or from other organizations, or to fund the accounts of its branches, franchises or agents, or of another organization.

In another embodiment, data processor 54 processes the payment instruction data provided by employer 52 into a NACHA CTX format which contains an Accredited Standards Committee (ASC) X12 820 Payment Order/Remittance Advice Transaction Set. ASC X12 820 is an inter-industry standard setting authority for electronic data interchange (EDI). Use of the ASC X12 820 transaction set enables an employer 52 utilizing data processor 54 to send multiple payments with remittance information in one transaction to an agency. With a maximum allowance of 9,999 Addenda Records, the NACHA CTX format allows the entire ASC X12 820 transaction set to be “enveloped” within an ACH format. Described in further detail below, a first table of the ASC X12 820 transaction conveys a gross payment amount, while a second table details transaction information for each employee covered by those payments using a DED (Deduction) data segment. The DED segment conveys the same information as in the CCD+ convention, however, it does so within the structure of ASC X12 820 transaction set.

As used herein, a convention typically refers to a standard format for the presentation of data within a single addenda record. When that convention is incorporated into the ASC X12 820 transaction set, it is referred to as a data segment. Herein, references to a DED data segment will be to ASC X12 820 transactions as published by the Data Interchange Standards Association (DISA).

While FIG. 2 illustrates a single employer 52, it should be understood that multiple employers 52 can provide payment instructions to data processor 54. In such a scenario, data processor 54 consolidates the payment instructions from the multiple employers. For example, payment instructions from multiple employers 52 may be intended for routing to a particular state disbursement unit. Data processor 54 is configured to combine those payment instructions (e.g., from multiple employees of multiple employers) so that a single payment instruction may eventually be sent to that state disbursement unit. Likewise, data processor 54 may forward the formatted credit payment data to multiple financial institutions (e.g. employer banks 56 corresponding to multiple employers 52).

In one embodiment, once individual banks 56 receive the formatted payment instructions, those payment instructions are forwarded as an automated clearinghouse (ACH) credit payment with an addenda record, and employer bank 56 debits the employer's account.

In a specific embodiment, employer 52 is a NACHA ACH originator, and employer bank 56 is a NACHA originating financial institution. Data received by data processor 54 from employers 52 can be in any format that provides the necessary data to allow data processor 54 to properly generate properly formatted payment instructions. Examples of data formats that are provided by data processor 54 to employer's banks 56 include, but are not limited to, NACHA CCD+ and NACHA CTX.

With respect to the data that are contained in the addenda records of automated clearinghouse formats, NACHA operating rules stipulate the type of data that may be exchanged as well as which standards and formats are permitted. However, the structuring of the data therein contained is managed outside the NACHA rules. For example, the NACHA operating rules permit the exchange of certain electronic data interchange (EDI) messages or transaction sets (e.g., ASC X12 820) within the addenda records of the CTX format, but those standards are developed and maintained by other standards development organizations, such as ASC X12 and UN/EDIFACT.

The following record formats are used to convey entries through the ACH Network: File Header Record (the 1 record), Company/Batch Header Record (the 5 record), Entry Detail Record (the 6 record), Addenda Record (the 7 record), Company/Batch Control Record (the 8 record), and File Control Record (the 9 record).

An ACH file is bounded by one File Header Record and one File Control Record, which serve to facilitate transmission, identification and balancing of the file. A file may be comprised of one or more batches, which are denoted by the Company/Batch Header Record and Company/Batch Control Record. These records contain information specific to all of the entry detail records contained within that batch. A batch may house one or more entry detail records that share certain aspects according to NACHA operating rules. An entry detail record is the record that constitutes the payment order and is used within the banking system to execute electronic funds transfer and settlement. An addenda record is used to supply additional payment related information related to the payment issued in the entry detail record. Each addenda record includes an 80 position payment related information field within which this remittance detail is transmitted.

The CCD and CTX payment formats are used within the ACH Network to conduct the transfer of funds between business or government entities. To exchange data along with payments using EDI technology, addenda records are used. Under NACHA Operating Rules, a CCD format may be accompanied by only one Addenda Record, which may carry X12 data segments or elements or NACHA-endorsed banking conventions. A CCD entry accompanied by an addenda record is referred to as a CCD+. The CTX format allows for the provision of 9,999 addenda records, which must carry a full X12 transaction set or UN/EDIFACT message (the transaction set or message must be formatted correctly, including the envelope information, and in the case of the ASC X12 820, both Table 1 and Table 2 data, as described above.

The NACHA record formats for CCD+ entries flow in the following order:

| | |
|---|---|
| File Header Record | |
| Company/Batch Header Record | |
| Entry Detail Record | |
| Addenda Record | (1 addenda with 80 byte |
| | Payment Related Information |
| | Field |
| Entry Detail Record | |
| Addenda Record | (1 addenda with 80 byte |
| | Payment Related Information |
| | Field |
| Entry Detail Record | |
| Addenda Record | (1 addenda with 80 byte |
| | Payment Related Information |
| | Field |
| Entry Detail Record | |
| Addenda Record | (1 addenda with 80 byte |
| | Payment Related Information |
| | Field |
| Company/Batch Control Record | |
| File Control Record | |

The NACHA record formats for CTX entries flow in the following order:

| | |
|---|---|
| File Header Record | |
| Company/Batch Header Record | |
| Entry Detail Record | |
| Addenda Record | (up to 9,999 addenda with |
| | 80 byte Payment Related |
| | Information Field) |
| Addenda Record | |
| Addenda Record | |
| Addenda Record | |
| Addenda Record | |
| Entry Detail Record | |
| Addenda Record | (up to 9,999 addenda with |
| | 80 byte Payment Related |
| | Information Field) |
| Addenda Record | |
| Addenda Record | |
| Addenda Record | |
| Addenda Record | |
| Addenda Record | |
| Company/Batch Control Record | |
| File Control Record | |

Within the 80 position Payment Related Information Field of the CCD+ Addenda Record, remittance information corresponding to the payment, (e.g. child support payment) made by an employer 52 is presented by data processor 54 in the following banking convention. This convention is referred to as the deduction data (DED) segment under ASC X12 820 syntax and is composed of ten fields: Segment Identifier, Application Identifier, Case Identifier, Pay Date, Payment Amount, Non-Custodial Parent Social Security Number, Medical Support Indicator, Non-Custodial Parent Name, FIPS Code, and Employment Termination Indicator.

Each field is referred to as a data element, which is the smallest named item in a record and can represent a qualifier, a value, or text. A data element has three primary attributes—length, field requirement, and type. Each data element is identified by an element identifier used for reference (e.g., DED01, DED02, etc.), and each element has a specific position within the record (segment). In constructing the segment, each data element is preceded by the separator character. In the ACH, the data element separator is an asterisk (‘*’). Each segment must end with a terminator, which in the ACH is a backslash (‘\’).

The following is an example of the DED segment as used in the Payment Related Information field of the CCD+ Addenda Record:DED* application identifier*case identifier*pay date*payment amount*non-custodial parent ssn*medical support indicator*non-custodial parent name*FIPS code* employment termination indicator\.

Rewriting the above utilizing a data example:

DED*CS*ZC146*951024*13547*975348431*N*SMITH,HAR*19000*Y\.

Data elements in a segment are either mandatory or optional. Data elements in a segment that are not mandatory as defined by the standard may be omitted. The omission of an optional element is noted by the placement of an asterisk in the place of that element. Also, if an optional data element is the last data element in a segment and that field is not being used, the preceding asterisk is replaced by the backslash.

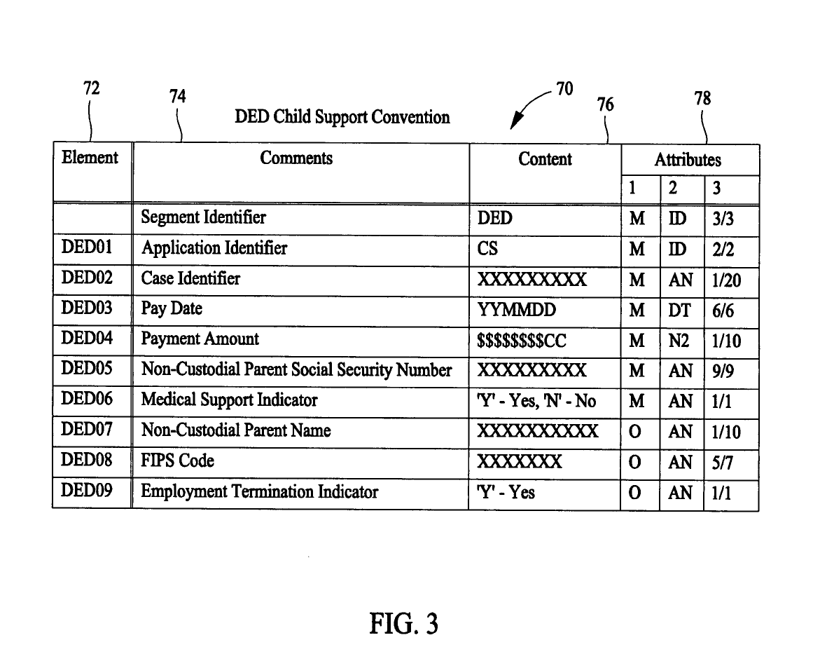

FIG. 3 is table 70 illustrating payment related information fields for child support payments according to the DED child support convention. The column headings used in table 70 include an element 72 which defines a data element name, comments 74 and content 76 which define the data element, and attributes 78 which are defined as field requirements, data types, and length. The first column of attributes 78 is the field requirement for that data element. An ‘M’ denotes a mandatory element, and an ‘O’ denotes an optional field. The second column of attributes 78 specifies the field data type. ‘AN’ denotes a string type data element. Contents of string data elements are a sequence of letters, digits, spaces and/or special characters (with the exception of the asterisk). The contents of such a data element are left justified, and trailing spaces are suppressed unless they are necessary to satisfy a minimum length requirement. ‘DT’ denotes a date type data element. Format for the date is YYMMDD. YY is the last two digits of the year (00-99), MM is the numeric value of the month (1-12), and DD is the numeric value of the day (1-31). The date field in the banking convention for CCD+ is a 6/6 date field, CCD+ does not support a 4 digit year. ‘ID’ denotes an identifier data element from a pre-defined list of values. ‘N₂’ denotes a numeric type data element with 2 decimal places to the right of a fixed, implied decimal point. A decimal point is not transmitted. Therefore an amount of $550.00 would appear as *55000*.

The third column of the attributes signifies the minimum and maximum lengths for an element. For example, ⅙ indicates that this data element must be at least one character, but not more than six.

The ten deduction data (DED) segments under ASC X12 syntax is further described, specifically, an application identifier supports a code value of ‘CS’, standing for child support. The application identifier indicates the type of deduction being withheld from an employee's pay. For example, an employer withholding child support from an employee's paycheck, uses ‘CS’ as the application identifier. Child support state disbursement units typically utilize one of the following application identifiers to identify their interstate payments; ‘II’ Interstate Income Withholding, ‘IT’ Interstate State Tax Offset, ‘10’ Interstate All Others, ‘RI’ Interstate Cost-Recovery Income Withholding, ‘RT’ Interstate Cost-Recovery State Tax Offset, and ‘RO’ Interstate Cost-Recovery All Others.

A case identifier element is the IV-D case number or court order number. The case identifier always refers to the identification number of the case in the state receiving the electronic funds transfer/electronic data interchange (EFT/EDI) transaction (e.g., the child support state disbursement unit). This is true whether the transaction is from an employer or another state. It is the responsibility of the state disbursement unit to provide the employer with the correct case identifier, typically during the case clean-up/reconciliation process before an employer sends the first electronic payments.

A pay date element provides the obligor's, for example, a non-custodial parent's, pay date, the date the income was withheld from the employee's paycheck. A payment amount element indicates the non-custodial parent's child support withheld for this pay period, which is being paid to the state disbursement unit. A non-custodial parent's Social Security number element provides the state disbursement unit with the non-custodial parent's Social Security number. A medical support indicator indicates whether the employer offers family medical insurance coverage. If medical insurance coverage is available, a ‘Y’ is placed in the field; if there is no coverage available, an ‘N’ is placed in the field. When one state disbursement unit is sending an interstate payment to another state and the payment is not from income-withholding (e.g., a lottery seizure), the state disbursement unit sending the payment may enter a “W” to indicate that the medical support indicator is not applicable. Employers typically will not utilize “W” as a code value.

A non-custodial parent's name element indicates the first seven letters of the obligor's last name followed by the first three letters of his/her first name. A comma is used to separate the last name from the first name of the non-custodial parent when the last name is less than seven characters. This field is not case-sensitive, i.e., mixed case letters are acceptable. A Federal Information Process Standard (FIPS) code refers to the FIPS Code of the state disbursement unit receiving the transaction. The FIPS code is 5 characters when indicating both the state and county codes. The FIPs code is 7 characters when indicating state, county, and local codes. An employment termination indicator is used to notify the child support enforcement agency that an individual's employment has terminated. A ‘Y’ is placed in this field if the employee has been terminated, otherwise the field is not used. The payment amount field may contain zero when this field is used. If an employer's payroll system is unable to generate the employment termination indicator, the employer is required to notify the child support enforcement agency (by phone, e-mail or mail) when an employee with an obligation has left its employment.

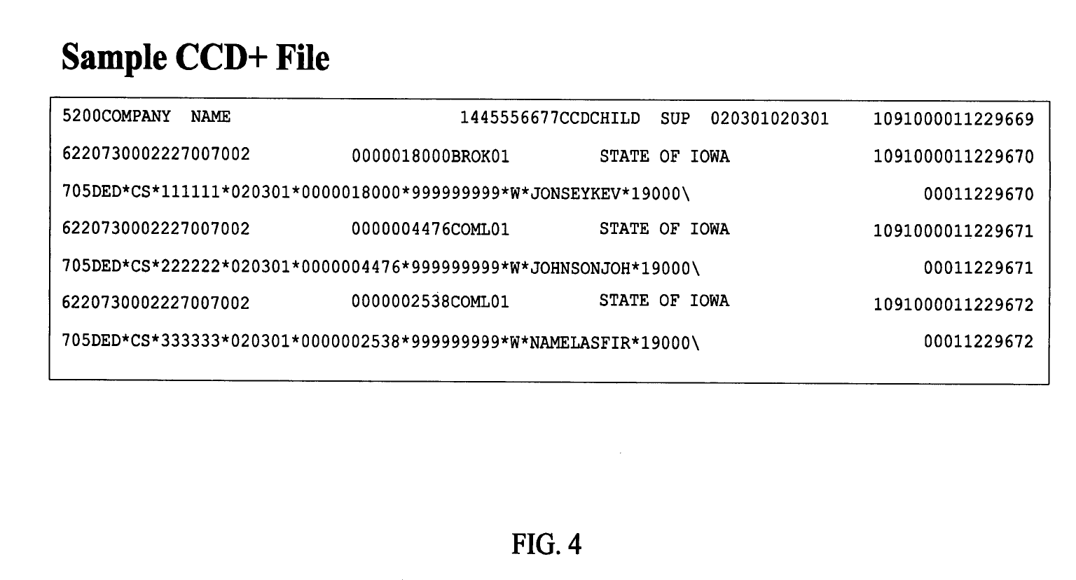

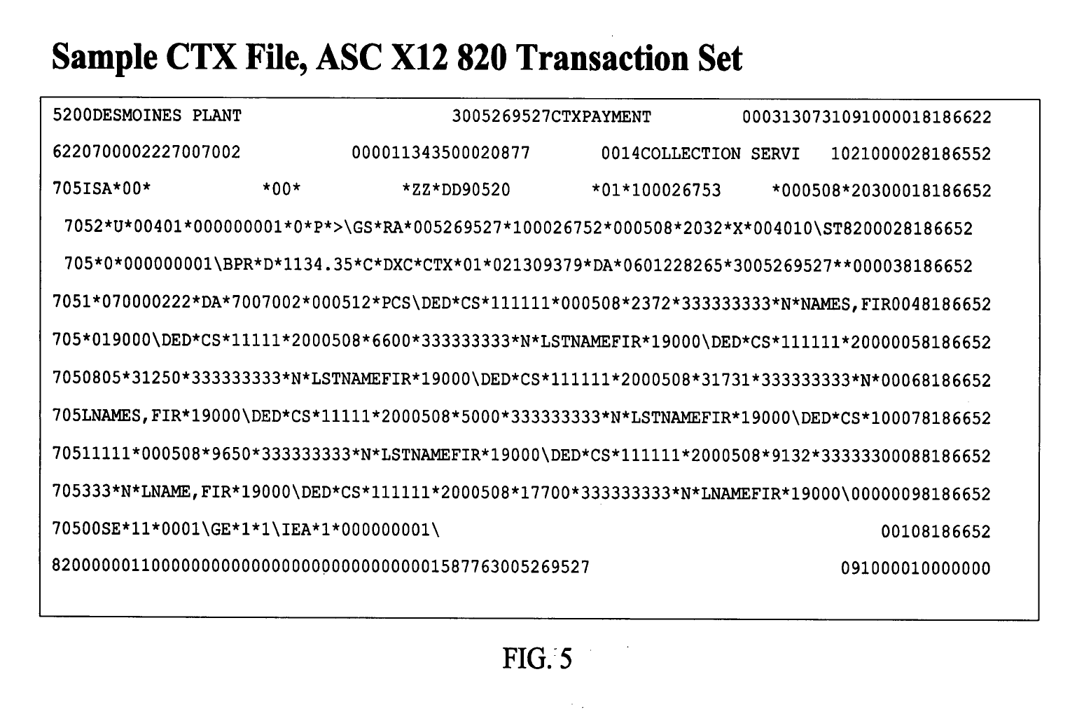

FIG. 4 is an example CCD+ file illustrating three examples of payment related information fields. FIG. 5 is an example CTX file utilizing an ASC X12 820 transaction set and illustrating eight examples of child support payment related information fields within an addenda record.

The following is a description of transaction data similar to the data found in the CTX file of FIG. 5 and which may be transmitted from data processor 54 to employer's bank 56 (both shown in FIG. 2). ISA is an interchange control header used to start and identify an interchange of functional groups and interchange-related control segments. GS is a functional group header and is used to indicate the beginning of a functional group and to provide control information. ST is a segment identifier, 820 is a transaction set identifier 820, and 0001 is a control number.

BPR is a Segment identifier. The first C indicates the payment and remittance advice are together. 55947 is the monetary amount ($559.47). This is the total of all DED loops included in the transaction set. The second C indicates the instruction is a credit. ACH indicates the payment method is the Automated Clearing House. CTX is the Payment Format Code indicating a Corporate Trade Exchange Payment. 01 is an ID qualifier indicating the identifier used in the next field will be an ABA transit routing number. 014321009 is the identification number of the originating financial institution. DA is an ID qualifier indicating the type of bank account used is a Demand Deposit. 123412345 is the originator's bank account number. 345389001 is the originating company identifier. 01 is an ID qualifier indicating the identifier used in the next field will be an ABA transit routing number. 987654321 is the identification number of the receiving financial institution. DA is an ID qualifier indicating the type of bank account used is a Demand Deposit. 121004861234 is the receiving bank account number. 20021229 is the effective entry date. PCS indicates the business reason for this payments is a Payment of Child Support.

TRN is a segment identifier. 1 indicates the trace type code is current transaction trace number. 1234570 is the control number used to tie funds to the remittance. DTM is a Segment identifier. 097 indicates the date that follows is the transaction creation date. 20021227 is the date (Dec. 27, 2002).

DED is a segment identifier. CS indicates this is a child support payment. ZC146 is the case identifier element. This can be the IV-D case number or court order number. The case identifier always refers to the identification number of the case in the state receiving the EFT/EDI transaction. This is true whether the transaction is from an employer or another state. The child support receiving agency (state disbursement unit) determines which number is used. 20021230 provides the obligor's (non custodial parent's) pay date or the date of income-withholding. 13447 is the non-custodial parent's withholding amount ($134.47) for this pay period being paid to the state disbursement unit. 789456123 is the Social Security number of the non-custodial parent. N indicates that there is no family medical coverage available through his/her employer. If medical coverage is available through his/her employer, a “Y” is used. SMITH,JOHN indicates the first seven letters of the non-custodial parent's last name followed by at least the first three letters of his/her first name. A comma is used to separate the last name from the first name of the non-custodial parent when the last name is less than seven characters. 17000 this is the federal information process standard (FIPS) code of the child support entity receiving the transaction. It is five characters when indicating both the state and county codes. It is seven characters when indicating state, county, and local codes. Y this is the employment termination indicator and is only used if an employee has been terminated.

SE is a transaction set trailer. This is the control segment used to indicate the end of the transaction set and to provide the count of the transmitted segments. GE is a functional group trailer to indicate the end of a functional group and to provide control information. IEA is a control segment used to define the end of an interchange of one or more functional groups of interchange-related control segments or a combination of functional groups and interchange control segments.

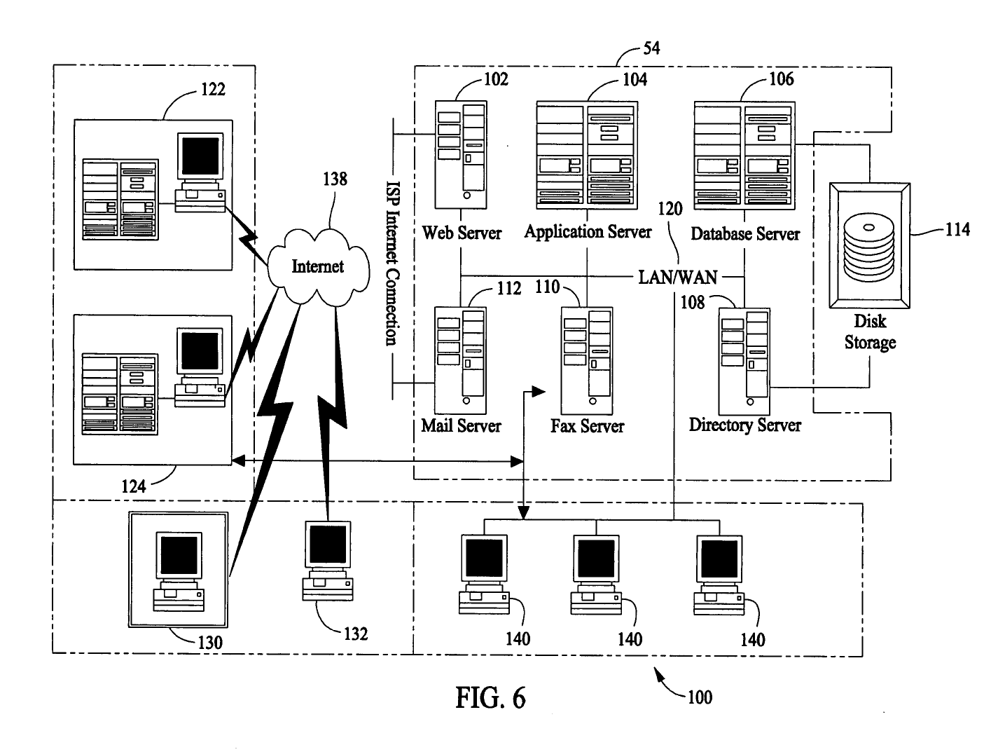

FIG. 6 is a block diagram of an exemplary embodiment of a system architecture for an electronic data communications network system 100 that could be utilized for the processing of payment instructions. System 100 is connected to a distributed computer network, such as the Internet, including that part of the Internet known as the World Wide Web. The term Web as used herein refers to the World Wide Web, wherein computers known as Web servers display graphical and textual information using files or “pages” composed in Hyper Text Mark-up Language (HTML). The Web servers communicate information over the Web or other network from a Web server at a central site to a remote computer system utilized by, for example, a financial institution. Although the exemplary system described herein is implemented on the Web, it should be understood that other types of distributed computer networks are suitable for being connected to system 100.

In one embodiment of system 100, the location of a page on the Web is specified by a uniform resource locator (URL), which is an alphanumeric string representing the server address on the Web. At the remote computer terminal, a remote user initially accesses a page by typing a specified URL into a Web-browser such as Netscape™ by Netscape Communications Corporation, or Internet Explorer™ by Microsoft Corporation. Multiple pages at a Web site are linked together via hyperlinks which are represented on a computer screen by a graphical icon such as a button or a highlighted line of text. Hyperlinks are configured to implicitly invoke another URL when a computer user clicks on a computer mouse button while a mouse-controlled screen cursor is positioned over a hyperlink icon.

In one embodiment, as shown in FIG. 6, computer system 100 includes data processor 54 (also shown in FIG. 2) that further includes a web server 102, an application server 104, a database server 106, a directory server 108, a fax server 110, and a mail server 112. A disk storage unit 114 is coupled to database server 106 and directory server 108 and provides a data repository for storing data pertaining to, for example, employer generated payment instructions. Servers 102, 104, 106, 108, 110 and 112 are coupled in either of a local area network (LAN) 120 or a wide area network (not shown). LAN 120 also includes a processor (not shown) programmed to communicate with servers 102, 104, 106, 108, 110, and 112. Servers 102, 104, 106, 108, 110 and 112 are configured to provide the functionality of data processor 54 (shown in FIG. 2).

Web server 102 and mail server 112 are configured to be communicatively coupled to computers 122 and 124 of individual employers, i.e., payment instruction providers, via an ISP Internet connection 128. In addition, a plurality of computers 130 and 132 of financial institutions (e.g. banks) that handle the accounts of the individual employers are communicatively coupled to web server 102 and mail server 112 via ISP Internet connection 138. Further, at least one work station 140 is coupled to LAN 120 for simultaneous monitoring of various payment processing tasks and methods described above. The processor is further programmed to communicate with employer computers 122 and 124 with bank computers 130 and 132 and with work station 140.

The communication in the exemplary embodiment is illustrated as being performed via the Internet through web browsers loaded onto computers 122, 124, 130, and 132 of employers and their banks, respectively. Embodiments exist where web browsers are not utilized. Specifically, computers 122 and 124 can be programmed to automatically transmit payment instructions to data processor 54 which converts the payment instructions into a format that is compatible with, or requested through, financial institution computers 130 and 132. Data processor 54 then automatically transmits the formatted payment instructions to computers 130 and 132. It is contemplated that a data set of payment instructions received from computer 122, for example, may be parsed at data processor 54, and separate portions of those received instructions be transmitted to each of computer 130 and computer 132.

Other wide area networks (WAN), however, could be used in other embodiments, i.e., the systems and processes described herein are not limited to being practiced over the Internet. LAN 120 is configured to store data obtained through an interface (not shown) such as a web page maintained on web server 102. System 100 is further configured to format payment instructions generated by employers into data formats requested by individual banks.

The architecture of system 100 is provided only as an example architecture that can be utilized to host a computer program that provides the payment processing functionality described herein. Other architectures are possible and can be utilized in connection with practicing the methods and providing a system for the herein described payment processing.

The credit payment processing systems and methods described herein facilitate deployment of automated credit withholdings from, for example, the wages of an employee by an employer, for the purposes of satisfying the obligations of the employee. As stated herein, such obligations may include child support payments, income tax withholdings, and the payment of back taxes. The technical effect of such systems and methods are that data regarding the credit payments are received from the employer, the data is then formatted into a form acceptable to, or requested by, a financial institution handling the accounts of the employer. The formatted data is then transmitted to the financial institution which initiates the above described ACH credit payment and debits the account of the employer. After passing through the ACH network, an account of an agency which disburses the funds is credited with a deposit in the amount of the credit payment originated by the employer.

While the invention has been described in terms of various specific embodiments, those skilled in the art will recognize that the invention can be practiced with modification within the spirit and scope of the claims.

1. A method of processing child support credit payment instructions comprising:
receiving payment instructions from one or more employers on behalf of one or more employees;
formatting the payment instructions into data formats specified by banks of the employers; and
forwarding the data formatted payment instructions to the banks of the employers.

2. A method according to claim 1 wherein receiving payment instructions comprises receiving payment instructions relating to at least one child support payment owed by an employee of an employer to a state disbursement unit.

3. A method according to claim 2 wherein formatting the payment instructions into a data format comprises prompting the employer to report data elements required by the state disbursement unit.

4. A method according to claim 3 wherein formatting the payment instructions into a data format comprises validating the employer reported data elements for compliance with state disbursement unit requirements.

5. A method according to claim 1 wherein formatting the payment instructions into a data format comprises providing the employer with confirmation whether or not a payment instruction substantially complies with published data specifications of the state disbursement unit.

6. A method according to claim 1 wherein formatting the payment instructions into a data format comprises providing an employer an opportunity to review and modify payment instructions prior to forwarding the data formatted payment instructions.

7. A method according to claim 1 further comprising providing an employer an opportunity to review payment instructions that have been forwarded for processing.

8. A method according to claim 1 wherein the employer is a NACHA automated clearinghouse (ACH) originator.

9. A method according to claim 1 wherein the bank of the employer is a NACHA originating depository financial institution.

10. A method for processing child support payments withheld from wages of employees by employers, said method comprising:
receiving child support payment instructions from the employers at a data processor;
consolidating the payment instructions from the employers at the data processor;
formatting the child support payment instructions at the data processor into a data format specified by the banks of the employers; and
transmitting the data formatted child support payment instructions to the banks of the employers.

11. A method according to claim 10 wherein formatting the payment instructions into a data format comprises formatting the payment instructions into at least one of a NACHA CCD+ message format and a NACHA CTX message format.

12. A method according to claim 10 wherein formatting the payment instructions into a data format comprises formatting remittance details in an 80 character payment related information field within a single addenda record of a CCD+ formatted message.

13. A method according to claim 10 wherein formatting the payment instructions into a data format comprises:
formatting payment instructions for multiple child support payments due to a single state disbursement unit utilizing an accredited standards committee (ASC) X12 820 payment order/remittance advice transaction set; and
forwarding the formatted payment instructions within a NACHA CTX message.

14. A computer system programmed to:
receive payment instructions from at least one employer relating to one or more employees;
convert the payment instructions into a data format specified by banks of the at least one employer; and
forward the converted payment instructions to the banks of the at least one employer.

15. A computer system according to claim 14 wherein the payment instructions are instructions relating to child support payments withheld from the wages of an employee by an employer.

16. A computer system according to claim 14 wherein the payment instructions are NACHA automated clearinghouse (ACH) originator instructions.

17. A computer system according to claim 14 wherein the converted payment instructions are compatible with a NACHA originating financial institution instruction format.

18. A computer system according to claim 14 wherein to convert the payment instructions, said computer system formats the payment instructions into a one of a NACHA CCD+ message format and a NACHA CTX message format.

19. A computer system according to claim 14 wherein to convert the payment instructions, said computer system formats remittance details into an 80 character payment related information field within a single addenda record of a CCD+ formatted message.

20. A computer system according to claim 14 wherein to convert the payment instructions, said computer system:
formats payment instructions for multiple child support payments due to the same state disbursement unit utilizing an accredited standards committee (ASC) X12 820 payment order/remittance advice transaction set; and
forwards the formatted payment instructions within a NACHA CTX message.

21. A computer system according to claim 14 comprising a user interface through which one or more employers can enter payment instructions for payments owed to child support state disbursement units.

22. A computer program comprising:
a software module for receiving payment instructions from at least one employer, the payments being withheld from the wages of one or more employees;
a software module for converting the payment instructions into a data format specified by banks of the at least one employer; and
a software module for forwarding the converted payment instructions to the banks of the at least one employer.

23. A computer program according to claim 22 further comprising a software module for prompting the employer to enter data elements for the payment instructions that are required by a receiving state disbursement unit.

24. A computer program according to claim 23 further comprising a software module for presenting the entered data elements to the employer such that the employer can review and modify payment instructions prior to forwarding the payment instructions to the banks.

25. A computer program according to claim 23 further comprising a software module for validating entered data elements for compliance with state disbursement unit published specifications.

26. A computer program according to claim 25 further comprising a software module for generating one or more confirmation messages indicating whether or not a payment instruction substantially complies with state disbursement unit published specifications.

27. A computer program according to claim 25 wherein said software modules:
allow the employer to modify non-compliant payment instructions; and
forward the modified payment instructions to the banks.

28. A computer program according to claim 22 further comprising a software module allowing an employer to view payment instructions before the payment instructions are forwarded to the banks.

29. A computer program according to claim 22 further comprising a software module allowing an employer to cancel converted payment instructions before the payment instructions are forwarded to the bank of the employer.

30. A computer program according to claim 22 wherein said software module for converting the payment instructions converts the payment instructions into one of a NACHA CCD+ message format and a NACHA CTX message format.

31. A computer program according to claim 19 wherein said software module for converting the payment instructions converts the payment instructions into one of an 80 character payment related information field within a single addenda record of a CCD+ formatted message and an accredited standards committee (ASC) X12 820 payment order/remittance advice transaction set.
